(19) United States
(12) Patent Application Publication
(10) Pub. No.: US 2017/0344130 A1
(43) Pub. Date: Nov. 30, 2017

(54) CYLINDRICAL MOBILE DATA PROCESSING DEVICE AND METHODS FOR USING THE DEVICE

(71) Applicant: Haja Mohideen, Singapore (SG)

(72) Inventor: Haja Mohideen, Singapore (SG)

(21) Appl. No.: 15/164,649

(22) Filed: May 25, 2016

(51) Int. Cl. G06F 3/0346; G06F 3/0481; G06F 3/041; G06F 3/0485; G06F 3/14

(52) U.S. Cl. CPC G06F 3/0346; G06F 3/0485; G06F 3/1423; G06F 3/041; G06F 3/04817; G06F 2203/04806

(57) ABSTRACT

There is provided a cylindrical mobile data processing device comprising a first touchscreen display at a first end of the mobile data processing device; a second touchscreen display at a second end of the mobile data processing device; a data processor communicatively coupled to the first and the second touchscreen displays; and an orientation detection sensor communicatively coupled to the data processor. Methods of using the device are also provided.

### FIELD OF INVENTION

Embodiments of the present invention relate to a cylindrical mobile data processing device and methods for using the device.

### BACKGROUND

In the current market for smartphones, consumers do not have much variety in relation to the shape and configuration for smartphones. Smartphones typically are in the form of rectangular bars, with little deviation in relation to physical form.

Furthermore, the current graphical user interfaces for smartphones are substantially similar in relation to their operation, and there is also little deviation in this regard.

It is desirable for consumers to have more variety in relation to both physical configuration and graphical user interface for smartphones.

### SUMMARY

In a first aspect, there is provided a cylindrical mobile data processing device comprising a first touchscreen display at a first end of the mobile data processing device; a second touchscreen display at a second end of the mobile data processing device; a data processor communicatively coupled to the first and the second touchscreen displays; and an orientation detection sensor communicatively coupled to the data processor. It is advantageous that the orientation detection sensor is configured to detect an extent of rotation of the cylindrical mobile data processing device from a point of reference.

Preferably, the point of reference is fixed. It is also preferable that the extent of rotation determines a task carried out by the cylindrical mobile data processing device.

Each of the touchscreen displays can be configured to depict a user interface to configure an activation of a software application on each respective touchscreen display.

The task can be, for example, activating a software application, varying a size of a digital image in a digital image viewing application, scrolling the digital image in the digital image viewing application, scrolling readable digital content in a digital content viewing application, moving a digital selector in a list depiction application, moving a digital dial in a digital dial depiction application, dialling a telephone number in a digital dialler application, varying a volume of digital media content in a digital media content playback application, and so forth.

It is preferable that upon at least one prolonged instance of physical contact with the first touchscreen display, digital content depicted on the first touchscreen display is blanked on the first touchscreen display, the digital content is replicated on the second touchscreen display and a “home” screen is replicated on the first touchscreen display. The at least one prolonged instance of physical contact can be carried out using either a human appendage or a stylus, and the prolonged instance can be at least three seconds.

In a second aspect, there is provided a data processor implemented method for activating at least one task in a cylindrical mobile data processing device, the method comprising receiving, from a data processor, a bearing from a first reference axis, the bearing being a point of reference; receiving, from an orientation detection sensor, an extent of rotation of the cylindrical mobile data processing device from the point of reference; and processing, by the data processor, the extent of rotation to determine a task carried out by the cylindrical mobile data processing device.

Preferably, the at least one task is, for example, activating a software application, varying a size of a digital image in a digital image viewing application, scrolling the digital image in the digital image viewing application, scrolling readable digital content in a digital content viewing application, moving a digital selector in a list depiction application, moving a digital dial in a digital dial depiction application, dialling a telephone number in a digital dialler application, varying a volume of digital media content in a digital media content playback application and so forth.

In a third aspect, there is provided a non-transitory computer readable storage medium embodying thereon a program of computer readable instructions which, when executed by one or more processors of a cylindrical mobile data processing device, cause the cylindrical mobile data processing device to perform a method for activating at least one task, the method embodying the steps of receiving, from a data processor, a bearing from a first reference axis, the bearing being a point of reference; receiving, from an orientation detection sensor, an extent of rotation of the cylindrical mobile data processing device from the point of reference, and processing, by the data processor, the extent of rotation to determine a task carried out by the cylindrical mobile data processing device.

Preferably, the at least one task is, for example, activating a software application, varying a size of a digital image in a digital image viewing application, scrolling the digital image in the digital image viewing application, scrolling readable digital content in a digital content viewing application, moving a digital selector in a list depiction application, moving a digital dial in a digital dial depiction application, dialling a telephone number in a digital dialler application, varying a volume of digital media content in a digital media content playback application and so forth.

In a fourth aspect, there is provided a data processor implemented method for replicating digital content of a first touchscreen display and on a second touchscreen display, the method comprising receiving, at the first touchscreen display, at least one prolonged instance of physical contact; determining, at a data processor, a duration of the at least one prolonged instance of contact; blanking, at the first touchscreen display, the digital content on the first touchscreen display; and generating, at the second touchscreen display, the digital content on the second touchscreen display. The method can also further comprise generating, at the first touchscreen display, a “home” screen. Preferably, the duration can be at least three seconds.

In a fifth aspect, there is provided a non-transitory computer readable storage medium embodying thereon a program of computer readable instructions which, when executed by one or more processors of a mobile data processing device, cause the mobile data processing device to perform a method for replicating digital content of a first touchscreen display and on a second touchscreen display, the method embodying the steps of receiving, at the first touchscreen display, at least one prolonged instance of physical contact; determining, at a data processor, a duration of the at least one prolonged instance of contact; blanking, at the first touchscreen display, the digital content on the first touchscreen display; and generating, at the second touchscreen display, the digital content on the second touchscreen display. The method can also further embody the step of generating, at the first touchscreen display, a “home” screen. It is preferable that the duration is at least three seconds.

In a sixth aspect, there is provided a data processor implemented method for configuring activation of at least one task on a cylindrical mobile device including a first and a second touchscreen display, the method comprising contacting a first task icon in a first segment of an inner ring of a digital dial on the first touchscreen display; and rotating the task icon such that a first straight edge of the first segment is located at a first pre-defined bearing, the first straight edge being at a front of the first segment in a first direction of rotation. It is advantageous that rotation of the cylindrical mobile device to the first pre-defined bearing activates a first task on the first touchscreen display.

The method can further comprise contacting a second task icon in a second segment of the inner ring of the digital dial on the first touchscreen display; and translating the second task icon to a secondary segment of an outer ring of the digital dial on the first touchscreen display, a second straight edge of the secondary segment being located at a second pre-defined bearing, the second straight edge being at a front of the secondary segment in a second direction of rotation. Advantageously, rotation of the cylindrical mobile device to the second pre-defined bearing activates a second task on the second touchscreen display.

In a final aspect, there is provided a non-transitory computer readable storage medium embodying thereon a program of computer readable instructions which, when executed by one or more processors of a cylindrical mobile device including a first and a second touchscreen display, cause the cylindrical mobile data processing device to perform a method for configuring activation of at least one task, the method embodying the steps of contacting a first task icon in a first segment of an inner ring of a digital dial on the first touchscreen display; and rotating the first task icon such that a first straight edge of the first segment is located at a first pre-defined bearing, the first straight edge being at a front of the first segment in a first direction of rotation. It is advantageous that rotation of the cylindrical mobile device to the first pre-defined bearing activates a first task on the first touchscreen display.

The method can also further embody the steps of contacting a second task icon in a second segment of an inner ring of a digital dial on a first touchscreen display; and translating the second task icon to a secondary segment of an outer ring of the digital dial on the first touchscreen display, a second straight edge of the secondary segment being located at a second pre-defined bearing, the second straight edge being at a front of the secondary segment in a second direction of rotation. Advantageously, rotation of the cylindrical mobile device to the second pre-defined bearing activates a second task on the second touchscreen display.

### DESCRIPTION OF FIGURES

In order that the present invention may be fully understood and readily put into practical effect, there shall now be described by way of non-limitative example only, certain embodiments of the present invention, the description being with reference to the accompanying illustrative figures, in which:

FIG. 1 shows a schematic view of a possible embodiment of a cylindrical mobile data processing device of the present invention.

FIG. 2A-2F show a front, a rear, a side, a first side perspective, a second side perspective and a third side perspective view respectively of a possible embodiment of a cylindrical mobile data processing device of the present invention.

FIG. 3 shows a process flow of a data processor implemented method for activating at least one task in a cylindrical mobile data processing device.

FIG. 4 shows a process flow of a data processor implemented method for replicating digital content of a first touchscreen and on a second touchscreen.

FIG. 5 shows a process flow of a data processor implemented method for configuring activation of at least one task on a cylindrical mobile device.

FIG. 6 shows a possible embodiment of a user interface of a cylindrical mobile data processing device of the present invention.

FIG. 7 shows a possible depiction of the method of FIG. 4 being carried out.

FIG. 8 shows a possible depiction of the method of FIG. 3 being carried out.

FIG. 9 shows a possible depiction of an application of the method of FIG. 3.

FIG. 10 shows a possible depiction of a second application of the method of FIG. 3.

FIG. 11 shows a possible depiction of a third application of the method of FIG. 3.

FIG. 12 shows a possible depiction of a fourth application of the method of FIG. 3.

FIG. 13 shows a possible depiction of a fifth application of the method of FIG. 3.

### DETAILED DESCRIPTION

There is provided a cylindrical mobile data processing device which allows a user to have a different user experience compared to existing smartphones on the market. The different user experience relates to carrying out various tasks on the cylindrical mobile data processing device and an interface between the user and the cylindrical mobile data processing device.

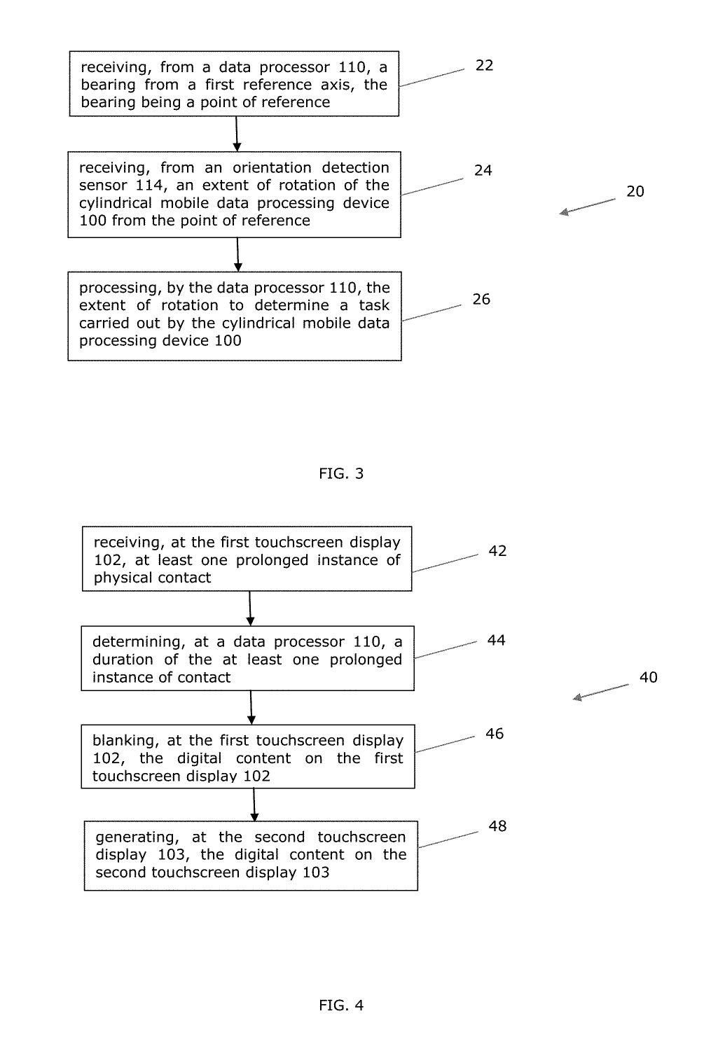

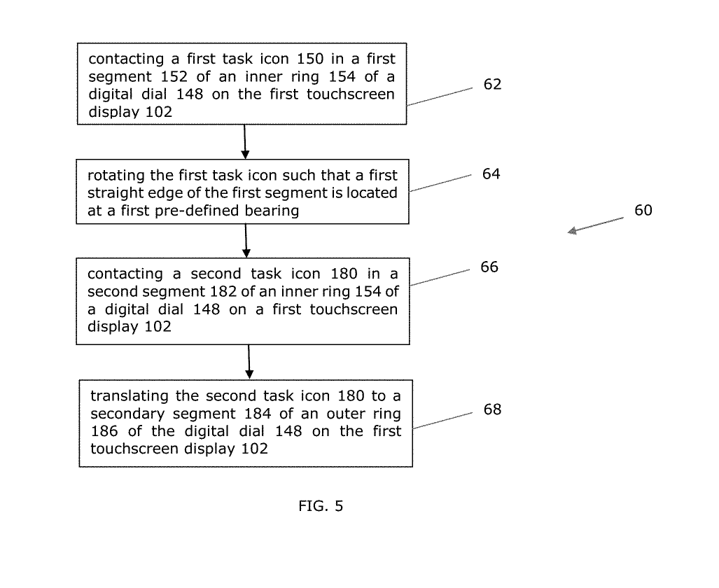

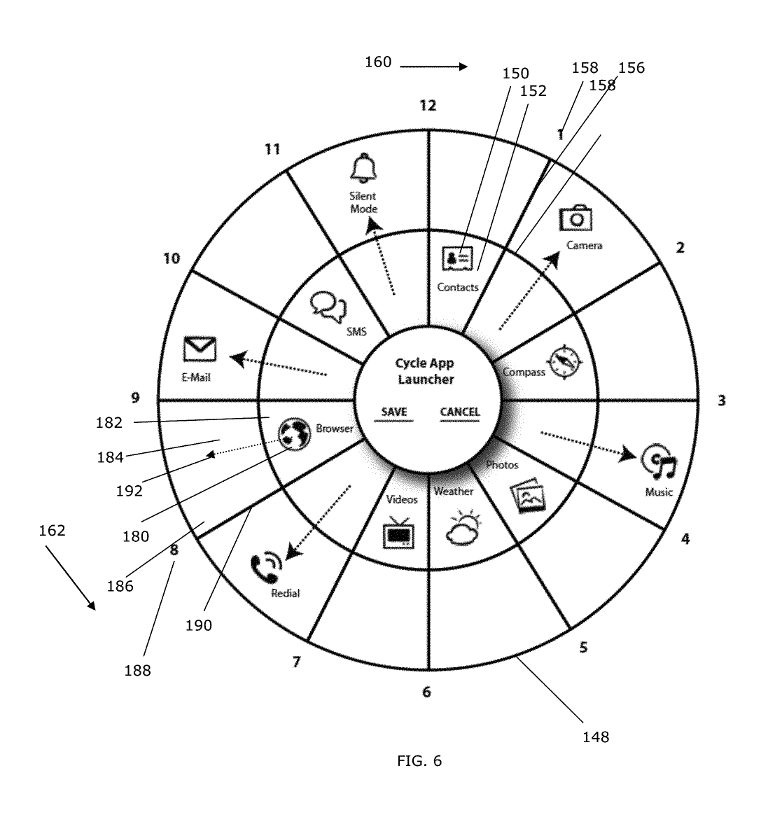

In the following description, various methods will be depicted in flow diagrams (FIG. 3, FIG. 4 and FIG. 5), and each of the blocks of the flow diagram may be executed by a data processor(s) or a portion of the data processor (for example, a single core of a multi-core processor). The processes may be embodied in a non-transient machine-readable and/or computer-readable medium for configuring a computer system to execute the method. In addition, a software module(s) may be stored within and/or transmitted to a computer system memory to configure the computer system to carry out the tasks indicated in each of the blocks of the flow diagram.

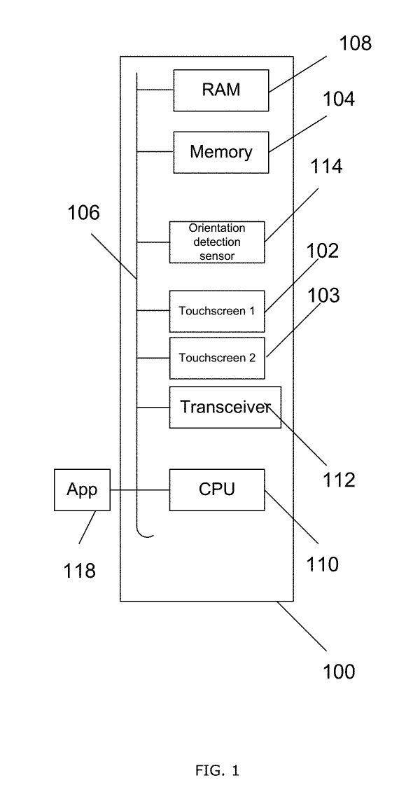

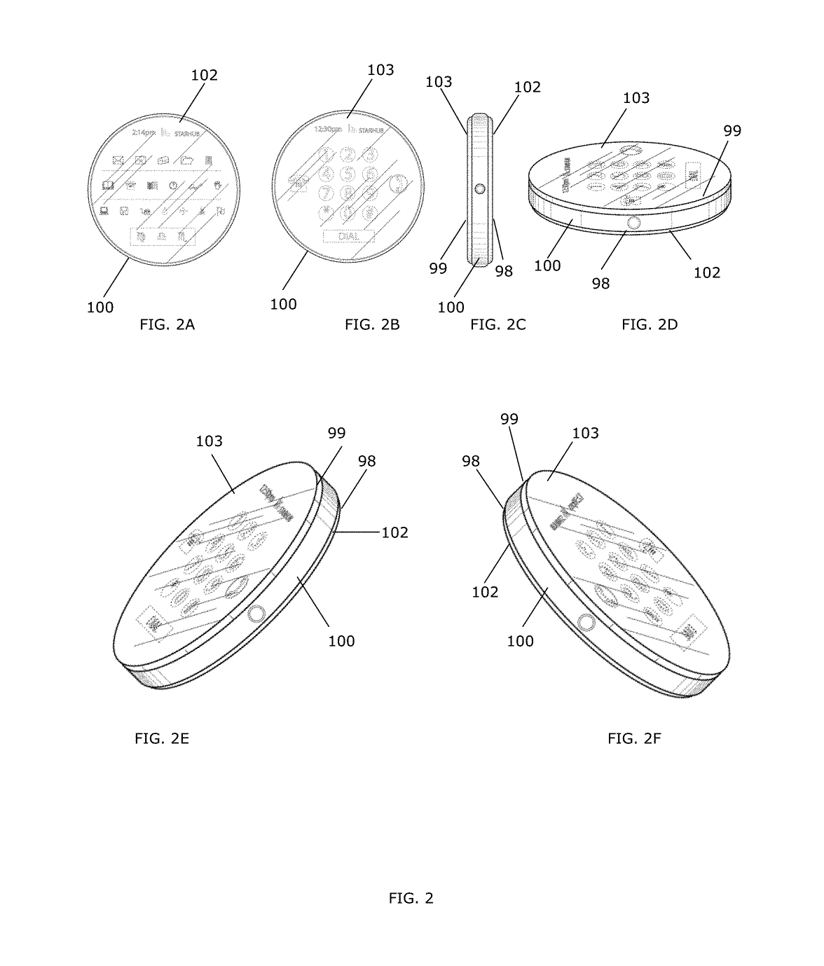

The various methods mentioned earlier can be carried out on a cylindrical mobile data processing device 100. A schematic diagram of the cylindrical mobile data processing device 100 is shown in FIG. 1 and various views of a possible embodiment of the cylindrical mobile data processing device 100 is shown in FIG. 2. The cylindrical mobile data processing device 100 can be a handheld device such as a smartphone. As shown in FIG. 1, the cylindrical mobile data processing device 100 includes the following components in electronic communication via a bus 106:
a first touchscreen display 102;
a second touchscreen display 103;
non-volatile memory 104;
random access memory (“RAM”) 108;
N processing components (data processor) 110;
a transceiver component 112 that includes N transceivers; and
at least one orientation detection sensor 114.

Although the components depicted in FIG. 1 represent physical components, FIG. 1 is not intended to be a hardware diagram; thus many of the components depicted in FIG. 1 may be realized by common constructs or distributed among additional physical components. Moreover, it is certainly contemplated that other existing and yet-to-be developed physical components and architectures may be utilized to implement the functional components described with reference to FIG. 1.

The first and second touchscreen displays 102, 103 generally operate to provide a presentation of content to a user, and may be realized by any of a variety of displays (for example, LCD, OLED displays). And in general, the non-volatile memory 104 functions to store (that is, persistently store) data and executable code including code that is associated with the functional components of the method. In some embodiments, for example, the non-volatile memory 104 includes bootloader code, modem software, operating system code, file system code, and code to facilitate the implementation of one or more portions of the method as well as other components well known to those of ordinary skill in the art that are not depicted for simplicity.

In many implementations, the non-volatile memory 104 is realized by flash memory (e.g., NAND or ONENAND memory), but it is certainly contemplated that other memory types may be utilized as well. Although it may be possible to execute the code from the non-volatile memory 104, the executable code in the non-volatile memory 104 is typically loaded into RAM 108 and executed by one or more of the N processing components 110.

The N processing components (data processor) 110 in connection with RAM 108 generally operate to execute the instructions stored in non-volatile memory 104 to effectuate the functional components. As one of ordinarily skill in the art will appreciate, the N processing components 110 may include a video processor, modem processor, DSP, graphics processing unit (GPU), and other processing components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The at least one orientation detection sensor 114 can be a gyroscope which is configured to detect a bearing of the cylindrical mobile data processing device 100.

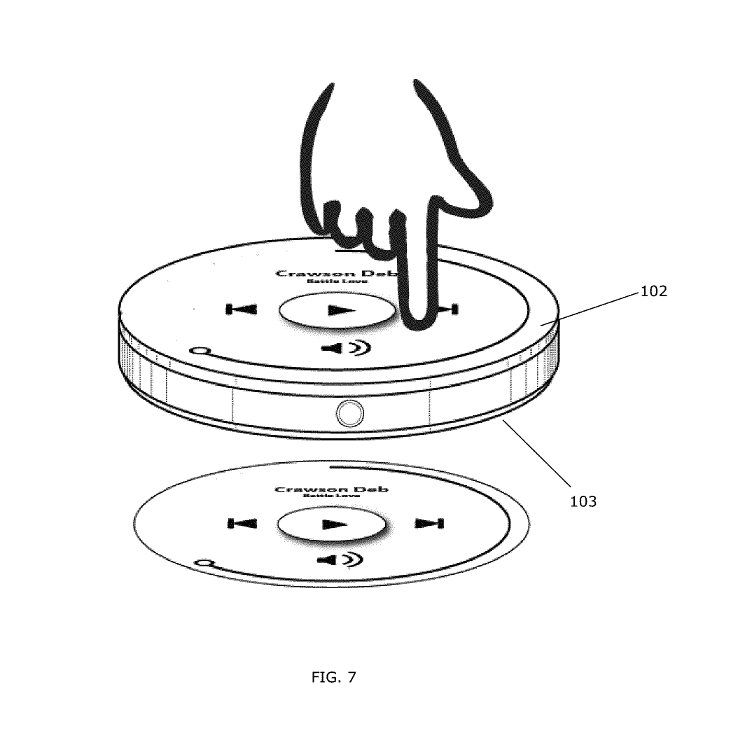

Referring to FIG. 2, various views of the cylindrical mobile data processing device 100 is shown. FIG. 2A shows a front view, 2B shows a rear view, 2C shows a side view, and 2D to 2F show side perspective views. The first touchscreen display 102 is at a first end 98 of the cylindrical mobile data processing device 100, and the second touchscreen display 103 is at a second end 99 of the cylindrical mobile data processing device 100. The data processor 110 is communicatively coupled to the first touchscreen display 102 and the second touchscreen display 103. In addition, the orientation detection sensor 114 is also communicatively coupled to the data processor 110. Typically, the orientation detection sensor 114 is configured to detect an extent of rotation of the cylindrical mobile data processing device 100 from a point of reference (can be either fixed or variable). Furthermore, each of the touchscreen displays 102, 103 can be configured to depict a user interface to configure an activation of a software application on each respective touchscreen. A possible embodiment of the user interface is shown in FIG. 6, and further details describing FIG. 6 will be provided in later paragraphs.

It should be appreciated that the extent of rotation of the cylindrical mobile data processing device 100 determines a task carried out by the cylindrical mobile data processing device 100. The task can be, for example, activating a software application, varying a size of a digital image in a digital image viewing application, scrolling the digital image in the digital image viewing application, scrolling readable digital content in a digital content viewing application, moving a digital selector in a list depiction application, moving a digital dial in a digital dial depiction application, dialling a telephone number in a digital dialler application, varying a volume of digital media content in a digital media content playback application and so forth. Further description of the various tasks will be provided in later paragraphs.

In addition, it is also possible that upon at least one prolonged instance of physical contact with the first touchscreen display 102, digital content depicted on the first touchscreen display 102 is blanked on the first touchscreen display 102, the digital content is replicated on the second touchscreen display 103, and a “home” screen is replicated at the first touchscreen display 102. It should be noted that the “home” screen is a default screen which appears whenever the cylindrical mobile data processing device 100 is activated from a standby mode or when the user wishes to access a software (app) installed on the cylindrical mobile data processing device 100. The at least one prolonged instance of physical contact can carried out using either a human appendage or a stylus. The prolonged instance is three seconds. FIG. 7 shows a possible embodiment of this aspect, and will be described in later paragraphs.

Referring to FIG. 3, there is provided a data processor implemented method for activating at least one task in a cylindrical mobile data processing device 100 (20). The cylindrical mobile data processing device 100 can be the device as described in the preceding paragraphs.

The method 20 comprises receiving, from a data processor 110, a bearing from a first reference axis, the bearing being a point of reference (22). Subsequently, the method 20 includes receiving, from an orientation detection sensor 114, an extent of rotation of the cylindrical mobile data processing device 100 from the point of reference (24), and processing, by the data processor 110, the extent of rotation to determine a task carried out by the cylindrical mobile data processing device 100 (26).

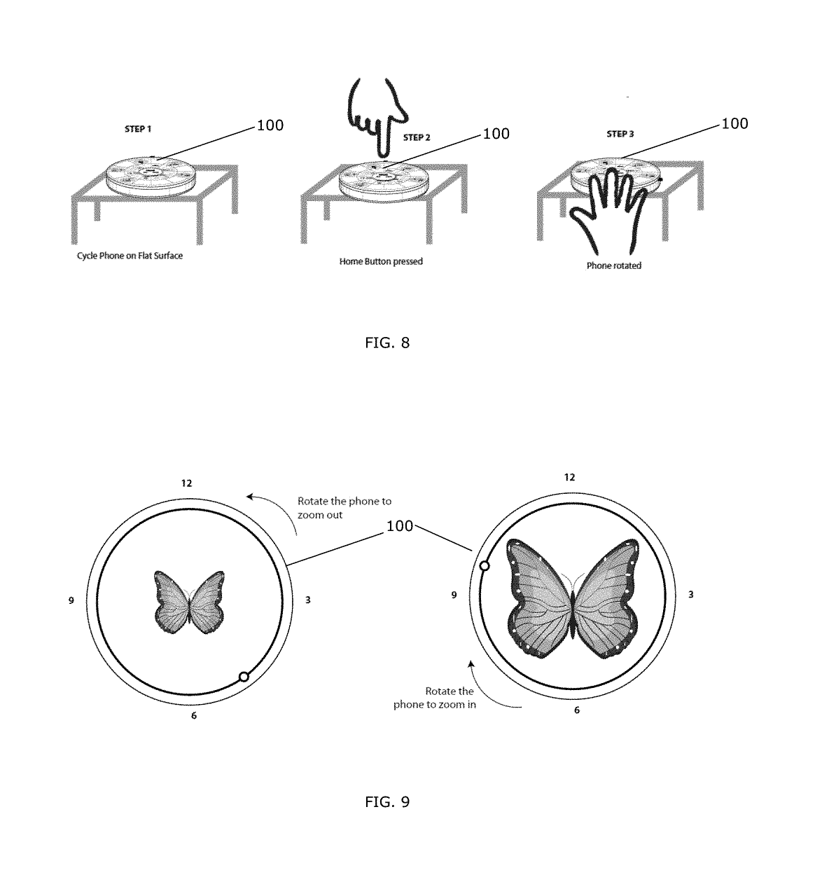

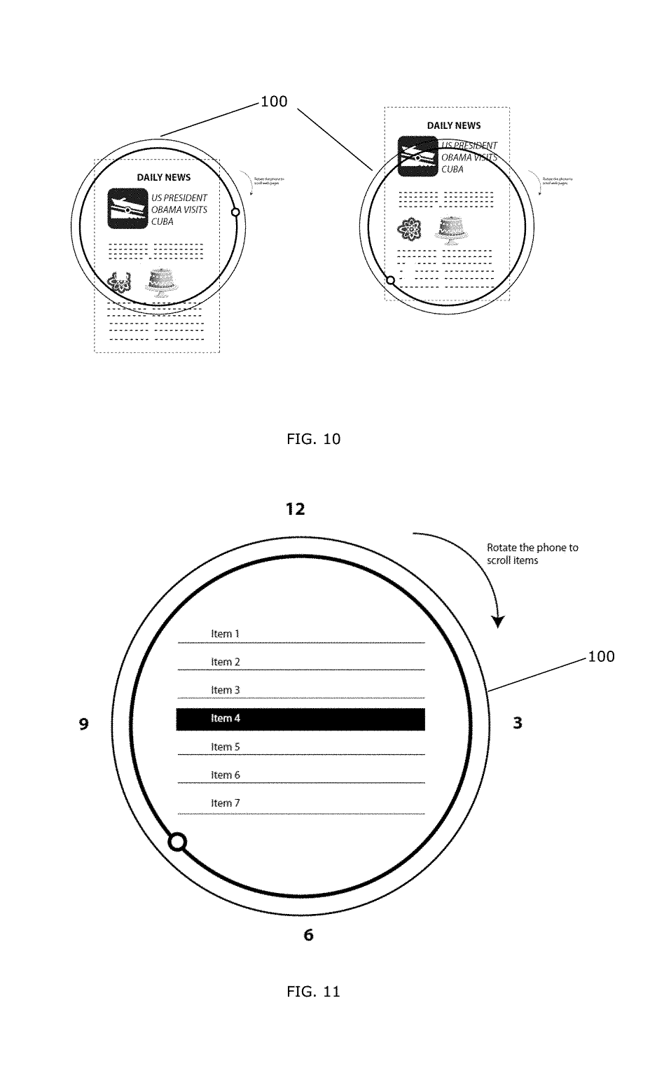

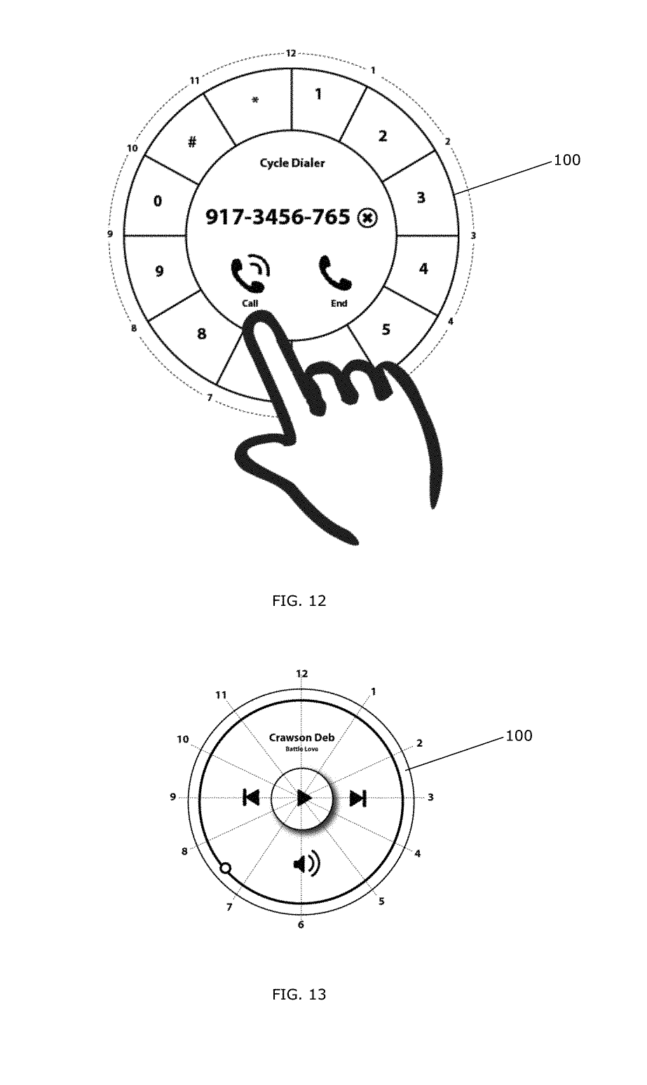

The at least one task can be, for example, activating a software application (FIG. 8 shows activation of a point of reference and rotation of the cylindrical mobile data processing device 100 to activate a task), varying a size of a digital image in a digital image viewing application (FIG. 9), scrolling the digital image in the digital image viewing application (not shown), scrolling readable digital content in a digital content viewing application (FIG. 10), moving a digital selector in a list depiction application (FIG. 11), moving a digital dial in a digital dial depiction application (not shown), dialling a telephone number in a digital dialler application (FIG. 12 shows a digital dialer where rotation of the cylindrical mobile data processing device 100 selected specific numeral digits), and varying a volume of digital media content in a digital media content playback application (FIG. 13 shows, for example, clockwise rotation increasing a volume of media playback).

Referring to FIG. 4, there is provided a data processor implemented method for replicating digital content of a first touchscreen display 102 and on a second touchscreen display 103 (40). The first touchscreen display 102 and on a second touchscreen display 103 can be of the cylindrical mobile data processing device 100. In such an instance, the method 40 can appear like as if digital content on the first touchscreen display 102 is pushed to the second touchscreen display 103 as shown in FIG. 7.

The method 40 comprises receiving, at the first touchscreen display 102, at least one prolonged instance of physical contact (42). The physical contact can be carried out using either a human appendage or a stylus. Then, the method 40 includes determining, at the data processor 110, a duration of the at least one prolonged instance of contact (44), the duration being at least three seconds. The method 40 then includes blanking, at the first touchscreen display 102, the digital content on the first touchscreen display 102 (46); and then generating, at the second touchscreen display 103, the digital content on the second touchscreen display 103 (48). Furthermore, a “home” screen can be subsequently generated at the first touchscreen display 102 (50). It should be noted that the “home” screen is a default screen which appears whenever the cylindrical mobile data processing device 100 is activated from a standby mode or when the user wishes to access a software (app) installed on the cylindrical mobile data processing device 100. It should be appreciated that the digital content generated on the second touchscreen display 103 can be laterally inverted to what is shown on the first touchscreen display 102, even though this is not shown in FIG. 7.

With reference to FIG. 5 and FIG. 6, there is also shown a data processor implemented method for configuring activation of at least one task (60) on a cylindrical mobile device 100 including a first 102 and a second touchscreen display 103, similar to the device described in the preceding paragraphs. The method 60 affects a manner that the cylindrical mobile device 100 activates at least one task.

The method 60 comprises contacting a first task icon 150 in a first segment 152 of an inner ring 154 of a digital dial 148 on the first touchscreen display 102 (62); rotating the task icon 150 such that a first straight edge 156 of the first segment 152 is located at a first pre-defined bearing 158, the first straight edge 156 being at a front of the first segment 152 in a first direction of rotation 160. In the method 60, rotation of the cylindrical mobile device 100 to the first pre-defined bearing 158 activates the first task on the first touchscreen display 102 (shown to be a contacts address book).

The method 60 can further comprise contacting a second task icon 180 in a second segment 182 of the inner ring 154 of the digital dial 148 on the first touchscreen display 102 (66); and translating 192 the second task icon 180 to a secondary segment 184 of an outer ring 186 of the digital dial 148 on the first touchscreen display 102, a second straight edge 190 of the secondary segment 184 being located at a second pre-defined bearing 188, the second straight edge 190 being at a front of the secondary segment 184 in a second direction of rotation 162 (68). In the method 60, rotation of the cylindrical mobile device 100 to the second pre-defined bearing activates a second task on the second touchscreen display 103 (shown to be a web browser).

Based on the preceding description, it should be noted that the described device and methods offer the user with an apparatus with a different form factor compared to what is presently available to the users, and is also able to provide the users with a different manner of interacting with their mobile device. In some aspects, the interaction is intuitive, akin to rotating a control knob of a device to control an aspect of the device.

Whilst there have been described in the foregoing description preferred embodiments of the present invention, it will be understood by those skilled in the technology concerned that many variations or modifications in details of design or construction may be made without departing from the present invention.

1. A cylindrical mobile data processing device comprising:
a first touchscreen display at a first end of the mobile data processing device;
a second touchscreen display at a second end of the mobile data processing device;
a data processor communicatively coupled to the first and the second touchscreen displays; and
an orientation detection sensor communicatively coupled to the data processor,
wherein the orientation detection sensor is configured to detect an extent of rotation of the cylindrical mobile data processing device from a point of reference.

2. The cylindrical mobile data processing device of claim 1, wherein the point of reference is fixed.

3. The cylindrical mobile data processing device of either claim 1 or 2, wherein the extent of rotation determines a task carried out by the cylindrical mobile data processing device.

4. The cylindrical mobile data processing device of any of claims 1 to 3, wherein each of the touchscreen displays is configured to depict a user interface to configure an activation of a software application on each respective touchscreen display.

5. The cylindrical mobile data processing device of any of claims 1 to 3, wherein the task is selected from a group consisting of: activating a software application, varying a size of a digital image in a digital image viewing application, scrolling the digital image in the digital image viewing application, scrolling readable digital content in a digital content viewing application, moving a digital selector in a list depiction application, moving a digital dial in a digital dial depiction application, dialling a telephone number in a digital dialler application, and varying a volume of digital media content in a digital media content playback application.

6. The cylindrical mobile data processing device of any of claims 1 to 3, wherein, upon at least one prolonged instance of physical contact with the first touchscreen display, digital content depicted on the first touchscreen display is blanked on the first touchscreen display, the digital content is replicated on the second touchscreen display and a “home” screen is replicated on the first touchscreen display.

7. The cylindrical mobile data processing device of claim 6, wherein the at least one prolonged instance of physical contact is carried out using either a human appendage or a stylus.

8. The cylindrical mobile data processing device of either claim 6 or 7, wherein the prolonged instance is at least three seconds.

9. A data processor implemented method for activating at least one task in a cylindrical mobile data processing device, the method comprising:
receiving, from a data processor, a bearing from a first reference axis, the bearing being a point of reference;
receiving, from an orientation detection sensor, an extent of rotation of the cylindrical mobile data processing device from the point of reference; and
processing, by the data processor, the extent of rotation to determine a task carried out by the cylindrical mobile data processing device.

10. The method of claim 9, wherein the at least one task is selected from a group consisting of: activating a software application, varying a size of a digital image in a digital image viewing application, scrolling the digital image in the digital image viewing application, scrolling readable digital content in a digital content viewing application, moving a digital selector in a list depiction application, moving a digital dial in a digital dial depiction application, dialling a telephone number in a digital dialler application, and varying a volume of digital media content in a digital media content playback application.

11. A non-transitory computer readable storage medium embodying thereon a program of computer readable instructions which, when executed by one or more processors of a cylindrical mobile data processing device, cause the cylindrical mobile data processing device to perform a method for activating at least one task, the method embodying the steps of:
receiving, from a data processor, a bearing from a first reference axis, the bearing being a point of reference;
receiving, from an orientation detection sensor, an extent of rotation of the cylindrical mobile data processing device from the point of reference, and
processing, by the data processor, the extent of rotation to determine a task carried out by the cylindrical mobile data processing device.

12. The storage medium of claim 11, wherein the at least one task is selected from a group consisting of: activating a software application, varying a size of a digital image in a digital image viewing application, scrolling the digital image in the digital image viewing application, scrolling readable digital content in a digital content viewing application, moving a digital selector in a list depiction application, moving a digital dial in a digital dial depiction application, dialling a telephone number in a digital dialler application, and varying a volume of digital media content in a digital media content playback application.

13. A data processor implemented method for replicating digital content of a first touchscreen display and on a second touchscreen display, the method comprising:
receiving, at the first touchscreen display, at least one prolonged instance of physical contact;
determining, at a data processor, a duration of the at least one prolonged instance of contact;
blanking, at the first touchscreen display, the digital content on the first touchscreen display; and
generating, at the second touchscreen display, the digital content on the second touchscreen display.

14. The method of claim 13, wherein the duration is at least three seconds.

15. The method of either claim 13 or 14, further comprising generating, at the first touchscreen display, a “home” screen.

16. A non-transitory computer readable storage medium embodying thereon a program of computer readable instructions which, when executed by one or more processors of a mobile data processing device, cause the mobile data processing device to perform a method for replicating digital content of a first touchscreen display and on a second touchscreen display, the method embodying the steps of:
receiving, at the first touchscreen display, at least one prolonged instance of physical contact;
determining, at a data processor, a duration of the at least one prolonged instance of contact;
blanking, at the first touchscreen display, the digital content on the first touchscreen display; and
generating, at the second touchscreen display, the digital content on the second touchscreen display.

17. The storage medium of claim 16, wherein the duration is at least three seconds.

18. The storage medium of either claim 16 or 17, the method further embodying the step of generating, at the first touchscreen display, a “home” screen.

19. A data processor implemented method for configuring activation of at least one task on a cylindrical mobile device including a first and a second touchscreen display, the method comprising:
contacting a first task icon in a first segment of an inner ring of a digital dial on the first touchscreen display; and
rotating the task icon such that a first straight edge of the first segment is located at a first pre-defined bearing, the first straight edge being at a front of the first segment in a first direction of rotation,
wherein rotation of the cylindrical mobile device to the first pre-defined bearing activates a first task on the first touchscreen display.

20. The method of claim 19, further comprising:
contacting a second task icon in a second segment of the inner ring of the digital dial on the first touchscreen display; and
translating the second task icon to a secondary segment of an outer ring of the digital dial on the first touchscreen display, a second straight edge of the secondary segment being located at a second pre-defined bearing, the second straight edge being at a front of the secondary segment in a second direction of rotation,
wherein rotation of the cylindrical mobile device to the second pre-defined bearing activates a second task on the second touchscreen display.

21. A non-transitory computer readable storage medium embodying thereon a program of computer readable instructions which, when executed by one or more processors of a cylindrical mobile device including a first and a second touchscreen display, cause the cylindrical mobile data processing device to perform a method for configuring activation of at least one task, the method embodying the steps of:
contacting a first task icon in a first segment of an inner ring of a digital dial on the first touchscreen display; and
rotating the first task icon such that a first straight edge of the first segment is located at a first pre-defined bearing, the first straight edge being at a front of the first segment in a first direction of rotation,
wherein rotation of the cylindrical mobile device to the first pre-defined bearing activates a first task on the first touchscreen display.

22. The storage medium of claim 21, the method further embodying the steps of:
contacting a second task icon in a second segment of an inner ring of a digital dial on a first touchscreen display; and
translating the second task icon to a secondary segment of an outer ring of the digital dial on the first touchscreen display, a second straight edge of the secondary segment being located at a second pre-defined bearing, the second straight edge being at a front of the secondary segment in a second direction of rotation,
wherein rotation of the cylindrical mobile device to the second pre-defined bearing activates a second task on the second touchscreen display.
